(19) United States
(12) Patent Application Publication
(10) Pub. No.: US 2006/0226664 A1
(43) Pub. Date: Oct. 12, 2006

(54) Keyless remote door unlatching, unlocking and opening system

(76) Inventors: James D. Edwards, St. Augustine, FL (US); Robin Jody Kemp, Lyons, GA (US)

Correspondence Address: ROGERS TOWERS, P.A., 1301 RIVERPLACE BOULEVARD, SUITE 1500, JACKSONVILLE, FL, 32207, US

(21) Appl. No.: 11/398,351

(22) Filed: Apr. 5, 2006

Related U.S. Application Data
(60) Provisional application No. 60/668,689, filed on Apr. 6, 2005.

(51) Int. Cl. E05B 15/02

(52) U.S. Cl. 292/341.16

(57) ABSTRACT

A keyless remote control door unlatching, unlocking and opening system comprising a remote transmitter to send a signal to actuate a pair of solenoids located in a door jamb opposite the latch bolt and the dead bolt. The push rods of the solenoids force the dead bolt and the latch bolt out of the strike plates and immediately retract. Contact with the angled contact surface of the latch bolt causes the door to pivot open.

This application claims the benefit of U.S. Provisional Patent Application Ser. No. 60/668,689, filed Apr. 6, 2005.

### BACKGROUND OF THE INVENTION

This invention relates generally to the field of keyless remote door unlatching and unlocking systems, wherein an entryway door into a residence, office or the like can be unlatched and/or unlocked by remote operation of a transmitter. Even more particularly, the invention relates to keyless remote door unlatching and unlocking systems wherein both a door latch and a dead bolt can be remotely unlocked and unlatched simultaneously, and even more particularly wherein the operation of the unlatching and unlocking system initiates movement of the door on its hinges, causing the door to open.

A typical entryway door comprises a rectangular panel mounted to a door jamb by a plurality of hinges disposed along one vertical edge of the door and doorjamb. Such doors often have both a latching mechanism and a dead bolt locking mechanism. The latching mechanism utilizes a latch bolt that is spring-biased in the extended position yet is freely retracting when pressure is applied against its exposed end. The exposed end of the latch bolt has an angled or curved striking surface, such that during closure of the door the striking surface of the latch bolt contacts the strike plate mounted on the door jamb. The angled or curved striking surface of the latch bolt, in combination with a curved, extended portion of the strike plate, acts as a cam surface such that the latch bolt is depressed into the door, thereby allowing the door to be closed without turning the handle. When the door achieves the closed position relative to the door jamb, the latch bolt aligns with the bolt receiving aperture in the strike plate on the door jamb and the spring biasing member extends the latch bolt into the strike plate aperture to secure the door in the closed position. To manually open the door, the handle is actuated to retract the latch bolt from the strike plate and the door is pulled open. In most instances the latching mechanism can be locked, such that a key is used to prevent rotation of the door handle. Even with the door handle locked, the latch bolt is not prevented from being pressed into the retracted position upon contact with the strike plate, thereby allowing the door to be closed even if the latch is locked.

In addition to the latching mechanism, a dead bolt lock mechanism is often employed for greater security. The dead bolt lock mechanism utilizes a bolt having a generally perpendicular end such that no curved or angled surface is presented on the sides. The dead bolt is extended and retracted by turning a handle or a key mechanism. When in the extended position such that the dead bolt extends through the aperture in its strike plate, the bolt typically locks in the extended position such that it is difficult to push the bolt back into the door without turning the handle or key mechanism. Contrary to the latching mechanism, the dead bolt must be in the retracted position to either open or close the door.

Thus, many doors will have both a latching mechanism and a dead bolt locking mechanism that need to be opened to allow opening of the door. It is fairly common for an individual to be carrying objects when seeking access through the latched and locked door. To open the door, the individual must perform a balancing act with the carried objects or put the objects onto the ground while the key is obtained from a pocket or purse, the dead bolt is opened, the latch is unlocked and the door is pushed or pulled open.

To address this inconvenience, remote keyless systems have been developed, whereby the individual activates a remote control transmitter device that sends a signal to a receiver device, activating mechanisms that then unlatch or unlock the door. Examples of such systems are shown in U.S. Pat. No. 3,521,921 to Miyazaki, U.S. Pat. No. 4,679,834 to Gotanda, U.S. Pat. No. 4,907,429 to Davis et al., U.S. Pat. No. 5,474,342 to Smith et al., U.S. Pat. No. 5,729,198 to Gorman, U.S. Pat. No. 5,852,944 to Collard, Jr. et al., U.S. Pat. No. 5,911,460 to Hawkins et al., U.S. Pat. No. 5,943,888 to Lawson, U.S. Pat. No. 6,005,306 to Pickard, and U.S. Pat. No. 6,035,676 to Hudspeth. In many cases, the solution involves a complete redesign of the latching or dead bolt locking mechanisms, such that the systems cannot be applied to standard door and door jamb combinations, nor can the systems be utilized in retrofitting existing doorways. In addition, the systems also lack means to initiate self-opening of the door upon activation of the keyless remote control device.

It is an object of the this invention to provide a keyless remote control door unlatching and unlocking system useable with both door latch mechanisms and door dead bolt mechanisms. It is a further object to provide such a system wherein the system is employed with or utilizes standard door latch mechanisms and standard door dead bolt mechanisms. It is a further object to provide such a system wherein activation of the system to unlatch and unlock the door also results in automatic initiation of door opening movement.

### SUMMARY OF THE INVENTION

The invention comprises in general a system for the remote keyless unlatching and unlocking of a door closed with one or both of either a door latch mechanism or a dead bolt locking mechanism, such as typically found on the external doors of residences.

The system comprises a remote control transmitter device capable of transmitting a signal to a receiver module and a pair of solenoids actuated by the receiver module. Activation of the transmitter device causes extension of the push rods of the individual solenoids, which are aligned in the door jamb across from the door latch and the door dead bolt mechanisms, such that upon extension of the solenoid push rods the latch bolt and the dead bolt are contacted and pushed into the door sufficient distance to clear the strike plate mounted on the door jamb, thereby allowing movement of the door on its hinges such that it may be opened. Spring members automatically and immediately retract the push rods into the recessed or passive position so as not to interfere with the opening of the door. The push rod contacting the latch bolt is sized and aligned so as to strike the curved or angled contact surface of the latch bolt, and is mounted so as to extend sufficient depth such that full extension of the push rod against the curved or angled contact surface of the latch bolt initiates movement of the door on its hinges, the curved or angled contact surface of the latch bolt acting as a cam surface such that the door begins to open automatically. The system further comprises a dead bolt mechanism that is designed such that the dead bolt does not lock in the extended position and only light or minimal pressure is required to push the dead bolt back into the door.

### BRIEF DESCRIPTION OF THE DRAWINGS

FIG. 1 is an illustration of the keyless remote unlatching and unlocking system incorporated into a door jamb.

FIG. 2 is a top view of the solenoid and the latch bolt, illustrating the extension and automatic retraction movement of the push rod of the solenoid, as well as the movement of the latch bolt into the recessed or retracted position.

FIG. 3 is a view similar to FIG. 2, showing the push rod of the solenoid in the fully extended position, such that the contact surface of the latch bolt has acted as a cam and initiated movement of the door in the opening direction.

FIG. 4 is a view of a secondary initiator means that supplies additional force to open the door.

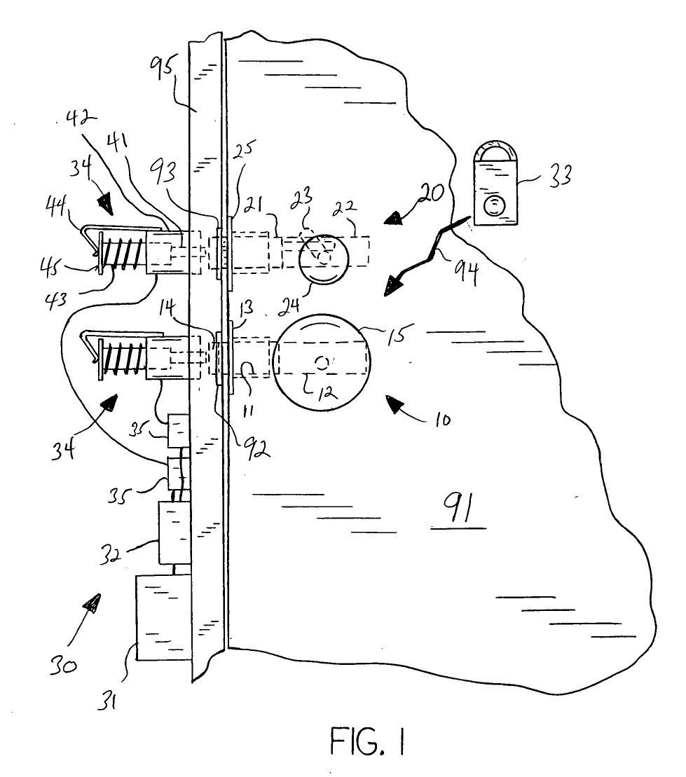

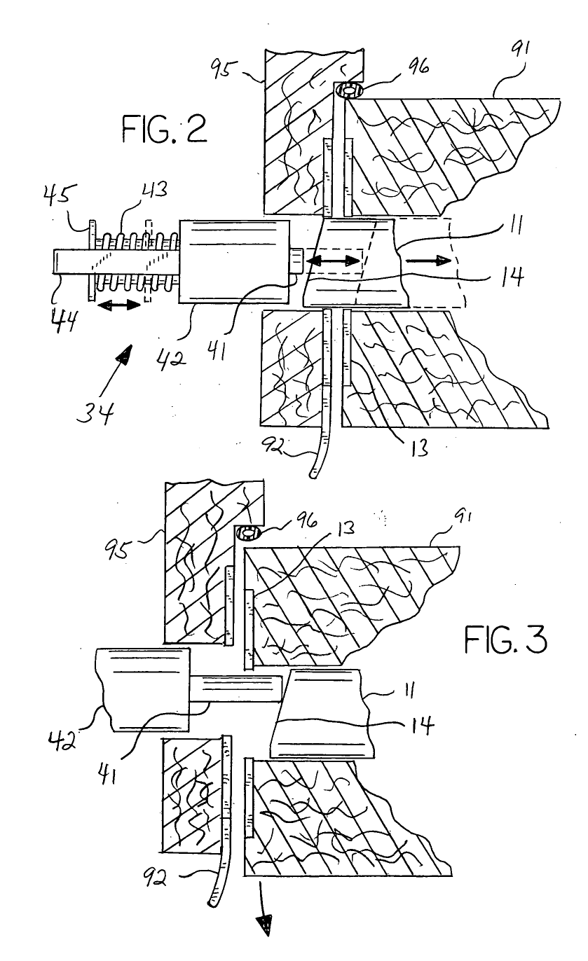

### DETAILED DESCRIPTION OF THE INVENTION

With reference to the drawings, the invention will now be described in detail with regard for the best mode and the preferred embodiment.

The invention is structured to be used with or to incorporate as original components a door latching mechanism 10 and a door dead bolt locking mechanism 20, both of which are installed in a door 91 in normal manner, the door 91 being pivotally mounted within a door jamb 95 in standard manner. The latching mechanism 10 comprises a latch bolt 11 moved by a slide mechanism 12 operated by a handle or knob 15, the latch bolt 11 extending through a face plate 13 attached to the door 91. The latch bolt 11 has a non-perpendicular contact surface 14, either curved or angled, such that when the contact surface 14 strikes the door jamb strike plate 92, the latch bolt 11 is pushed into the door 91, the latch bolt 11 being spring biased to remain in the extended position in the neutral or passive state. When the door 91 is completely closed, the latch bolt 11 automatically extends through the opening in the strike plate 92 to retain the door 91 in the closed position. Such latching mechanisms 10 are well known in the art.

The dead bolt locking mechanism 20 comprises a dead bolt 21 and a slide mechanism 22 including a trigger member 23, the dead bolt 21 being controlled by a locking handle 24, typically comprising a gripping member on the inside of door 91 and a keyed actuating member on the outside of door 91. The exposed end of the dead bolt 21 is retracted through a face plate 25 into the door 91 in order to allow opening and closing of door 91 and is extended through an opening in doorjamb strike plate 93 with the door 91 in the closed position to secure the door 91. Dead bolt locking mechanism 21 does not lock in the extended position, such that the dead bolt can be pushed into the door 91 by a small or minimal amount of pressure, typically about only 2 to 7 pounds. This operating parameter may be accomplished in standard dead bolt mechanisms 20 by rounding the edges of trigger 23, such that only 2 to 7 pounds of force are required to press the dead bolt 21 into the recessed or retracted position within door 91.

The operative control means 30 of the keyless remote unlatching and unlocking system of the invention comprise a transformer 31 which is connected to the structure's electrical system in standard manner, the transformer 31 reducing the voltage to 12 or 24 volts as required to operate the remaining components of the system. A receiver/controller means or module 32 comprises means to receive a signal 94 transmitted from a remote control transmitter 33, the signal 94 being a radio frequency transmission for example, and means to control operation of a pair of solenoids 34 through a pair of relays 35, all connected in electrical communication by standard wiring in electrical communication with the wiring system of the building. Alternatively, the system could be operated by battery power. Such components are known in the art.

The solenoids 34 are mounted in the door jamb 95 with one solenoid 34 opposite the latch bolt 11 and the other solenoid 34 opposite the dead bolt 21. The solenoids 34 each comprise a push rod 41 disposed within a housing 42, the housing 42 being mounted to the door jamb 95 using a bracket or other suitable means. A retracting spring 43 abutting a cap member 45 maintains the push rod 41 in the retracted position when the solenoid 34 is in non-operative status, i.e., until the solenoid 34 is activated. A backstop member 44 is affixed to the housing 42 and limits the rearward travel of the push rod 41 relative to the housing 42. Alternatively, an internal surface of the door jamb 95 or equivalent means could be used to limit the rearward travel. Upon activation, the push rods 41 are advanced against the latch bolt 1 and the dead bolt 21, with the push rods 41 extending a sufficient distance such that the latch bolt 11 and the dead bolt 21 are pushed into the recessed position, i.e., far enough into the door 91 to allow them to clear the strike plates 92 and 93 when the door 91 is opened. The operative period of the solenoid 34 is minimized by the control means 30 to be of short duration, such that the push rods 41 are immediately retracted back into the door jamb 95 by the biasing force of the retracting springs 43 after the push rods 41 reach maximum extension.

The extension of the push rod 41 opposite to the latch bolt 11 causes it to strike the angled contact surface 14 of the latch bolt 11. This causes the door 91 to pivot away from the door jamb 95 since the contact surface 14 acts as a cam, such that the door 91 begins to swing away from the door jamb 95 and open merely from the action of the solenoid 34, as shown in FIG. 3. Without movement of the door 91 out of the normally closed position, retraction of the push rod 41 would result in the automatic extension of the latch bolt 11 back into the strike plate 92, such that operation of the handle 15 would be required and the function of the invention would not be accomplished. Force to initiate opening of the door is also supplied by seal or gasket member 96, which is commonly disposed between the door 91 and the door jamb 95 to block passage of air. The seal 96 is made of a resilient material and is compressed when the door 91 is closed.

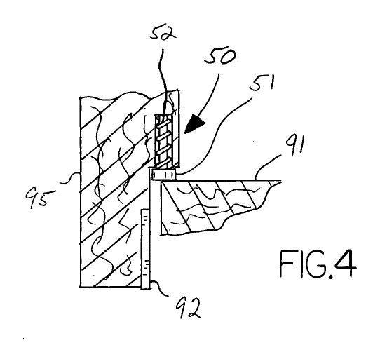

To further assist with the automatic opening of door 91, secondary initiator means 50 may be provided, as shown in FIG. 4. Such secondary initiator means 50 may be necessary if the door 91 is very heavy, or if the door 91 is improperly mounted such that it is slightly inclined from vertical. Secondary initiator means 50 comprises a biased assembly, such as a ram member 51 biased by a spring 52. Closure of the door 91 compresses the spring 52, creating stored energy that opens the door 91 when the latch bolt 11 is depressed into the door 91 by activation of the solenoid 34.

Operation of the door unlatching, unlocking and opening system as described herein is very simple. The user activates the signal 94 by depressing a button or the like on the transmitter 33. The signal 94 is received by the receiver 32 and the solenoids 34 are activated, thereby extending the push rods 41. This forces the latch bolt 11 and the dead bolt 21 out of the door jamb strike plates 92 and 93 and into the recessed or retracted position within door 91, such that the door 91 is not precluded from opening. The push rod 41 associated with the latch bolt 11 presses against the angled or curved contact surface of the latch bolt 11 and initiates movement of the door 91 in the opening direction. The push rods 41 are immediately retracted by the retracting springs 43, such that movement of the door 91 in the opening direction is not prevented by the push rods 41 themselves. Because the door 91 has begun to open, the latch bolt 11 is no longer aligned with the opening in the strike plate 92, such that when the latch bolt 11 automatically extends it does not seat within the strike plate 92 but instead abuts against the exposed face of the strike plate 92, thereby allowing the door 91 to pivot open on its own accord, assisted by the stored energy within the seal members 96 and, if present, secondary initiator means 50. Because the push rods 41 are recessed in the neutral or non-activated status, closure of the door 91 is accomplished in the standard manner.

It is contemplated that substitutions and equivalents for certain elements set forth above may be obvious to those skilled in the art, and therefore the true scope and definition of the invention is to be as set forth in the following claims.

We claim:

1. A door unlatching, unlocking and opening system comprising:
a door pivotally mounted within a door jamb, said door jamb having a latch strike plate and a bolt strike plate disposed thereon;
a door latching mechanism comprising a spring biased latch bolt having a non-perpendicular contact surface, whereby said latch bolt is forced into a recessed position within said door when said contact surface abuts said latch strike plate when said door is pivoted closed, and further whereby said latch bolt automatically extends into an opening of said latch strike plate when said door is fully closed;
a dead bolt locking mechanism comprising a dead bolt, said dead bolt being extendable into said bolt strike plate when said door is fully closed, whereby said dead bolt is movable into a recessed position by pressing against said dead bolt;
a pair of solenoids disposed within said door jamb, each of said solenoids comprising a push rod that extends through said one of said latch strike plates when said solenoid is activated and a retracting spring, whereby said push rod is retracted by said retracting spring when said push rod reaches maximum extension; and
operative control means to actuate said solenoids, said operative control means comprising a remote transmitter and receiver/controller means to receive a signal from said transmitter and to operate said solenoids;
such that upon actuation of said solenoids, one of said push rods forces said dead bolt into the recessed position within said door and the other of said push rods forces said latch bolt into the recessed position within said door, whereby contact between said push rod and said non-perpendicular contact surface of said latch bolt initiates pivoting movement of said door out of said closed position.

2. The system of claim 1, wherein less than 7 pounds of pressure is required to force said dead bolt into the recessed position within said door.

3. The system of claim 2, wherein approximately 2 pounds of pressure is required to force said dead bolt into the recessed position within said door.

4. The system of claim 2, wherein said dead bolt locking mechanism comprises a trigger member, and wherein said trigger member is rounded such that less than 7 pounds of pressure is required to force said dead bolt into the recessed position within said door.

5. The system of claim 3, wherein said dead bolt locking mechanism comprises a trigger member, and wherein said trigger member is rounded such that approximately 2 pounds of pressure is required to force said dead bolt into the recessed position within said door.

6. The system of claim 1, further comprising a seal member disposed on said door jamb, said seal member contacting and compressed by said door when said door is in the closed position, whereby said seal member also initiates pivoting movement of said door out of said closed position.

7. The system of claim 1, further comprising secondary initiator means mounted to said door jamb, said secondary initiator means comprising a ram member and a spring such that said spring is compressed when said door is in the closed position, whereby said secondary initiator means also initiates pivoting movement of said door out of said closed position.

8. A door unlatching, unlocking and opening system comprising:
a door pivotally mounted within a door jamb, said door jamb having a latch strike plate disposed thereon;
a door latching mechanism comprising a spring biased latch bolt having a non-perpendicular contact surface, whereby said latch bolt is forced into a recessed position within said door when said contact surface abuts said latch strike plate when said door is pivoted closed, and further whereby said latch bolt automatically extends into an opening of said latch strike plate when said door is fully closed;
a solenoid disposed within said door jamb, said solenoid comprising a push rod that extends through said latch strike plate when said solenoid is activated and a retracting spring, whereby said push rod is retracted by said retracting spring when said push rod reaches maximum extension; and
operative control means to actuate said solenoid, said operative control means comprising a remote transmitter and receiver/controller means to receive a signal from said transmitter and to operate said solenoid;
such that upon actuation of said solenoid, said push rod forces said latch bolt into the recessed position within said door, whereby contact between said push rod and said non-perpendicular contact surface of said latch bolt initiates pivoting movement of said door out of said closed position.

9. The system of claim 8, further comprising a seal member disposed on said door jamb, said seal member contacting and compressed by said door when said door is in the closed position, whereby said seal member also initiates pivoting movement of said door out of said closed position.

10. The system of claim 9, further comprising secondary initiator means mounted to said door jamb, said secondary initiator means comprising a ram member and a spring such that said spring is compressed when said door is in the closed position, whereby said secondary initiator means also initiates pivoting movement of said door out of said closed position.

11. The system of claim 9, wherein said non-perpendicular contact surface of said latch bolt is angled.

12. The system of claim 9, wherein said non-perpendicular contact surface of said latch bolt is curved.

13. A door unlatching, unlocking and opening system comprising:
a door pivotally mounted within a door jamb, said door jamb having a latch strike plate disposed thereon;
a door latching mechanism comprising a spring biased latch bolt having a non-perpendicular contact surface, whereby said latch bolt is forced into a recessed position within said door when said contact surface abuts said latch strike plate when said door is pivoted closed, and further whereby said latch bolt automatically extends into an opening of said latch strike plate when said door is fully closed;
a solenoid disposed within said door jamb, said solenoid comprising a push rod that extends through said latch strike plate when said solenoid is activated and a retracting spring, whereby said push rod is retracted by said retracting spring when said push rod reaches maximum extension; and
operative control means to actuate said solenoid, said operative control means comprising a remote transmitter and receiver/controller means to receive a signal from said transmitter and to operate said solenoid;
such that upon actuation of said solenoid, said push rod forces said latch bolt into the recessed position within said door, whereby said contact surface of said latch bolt functions as a cam surface such that contact between said push rod and said non-perpendicular contact surface of said latch bolt initiates pivoting movement of said door out of said closed position.

14. The system of claim 13, further comprising a seal member disposed on said door jamb, said seal member contacting and compressed by said door when said door is in the closed position, whereby said seal member also initiates pivoting movement of said door out of said closed position.

15. The system of claim 13, further comprising secondary initiator means mounted to said door jamb, said secondary initiator means comprising a ram member and a spring such that said spring is compressed when said door is in the closed position, whereby said secondary initiator means also initiates pivoting movement of said door out of said closed position.

16. The system of claim 13, wherein said non-perpendicular contact surface of said latch bolt is angled.

17. The system of claim 13, wherein said non-perpendicular contact surface of said latch bolt is curved.

18. The system of claim 13, further comprising:
a bolt strike plate disposed on said strike plate:
a dead bolt locking mechanism comprising a dead bolt, said dead bolt being extendable into said bolt strike plate when said door is fully closed, whereby said dead bolt is movable into a recessed position by pressing against said dead bolt;
a second solenoid disposed within said door jamb, said second solenoid comprising a push rod that extends through said bolt strike plate and a retracting spring, said second solenoid being operated by said operative control means, whereby said push rod is retracted by said retracting spring when said push rod reaches maximum extension;
such that upon actuation of said second solenoid, said second solenoid push rod forces said dead bolt into the recessed position within said door.

19. The system of claim 18, wherein less than 7 pounds of pressure is required to force said dead bolt into the recessed position within said door.

20. The system of claim 19, wherein approximately 2 pounds of pressure is required to force said dead bolt into the recessed position within said door.
